(19) United States
(12) Patent Application Publication
(10) Pub. No.: US 2014/0020981 A1
(43) Pub. Date: Jan. 23, 2014

(54) Self Levelling Support Apparatus

(71) Applicant: Eric Burden, Sussex (GB)

(72) Inventor: Eric Burden, Sussex (GB)

(21) Appl. No.: 13/980,724

(22) PCT Filed: Jan. 20, 2012
(86) PCT No.: PCT/EP12/50842

§ 371 Date: Oct. 7, 2013

(30) Foreign Application Priority Data
Jan. 21, 2011 (GB) 1101028.7

(51) Int. Cl. E06C 7/44

(52) U.S. Cl. CPC E06C 7/44
USPC 182/201

(57) ABSTRACT

A support apparatus includes at least first and second legs, and levelling means including: at the lower end of each of the first and second legs a cylinder and piston unit, wherein movement of the pistons of the cylinder and piston units relative to the cylinders permits variation in the length of each of the first and second legs; fluid communication means for establishing at least one closed fluid passageway between the cylinder and piston units; and valve means for controlling the passage of fluid through the fluid communication means. In a first position, the valve means permit fluid to flow between the cylinder and piston units via the fluid communication means such that the length of each of the legs is accommodated to the profile of the ground, and in a second position, the valve means do not permit fluid to flow between the cylinder and piston units thereby locking the cylinder and piston units in position.

The present invention relates to a support apparatus such as a ladder, step ladder or scaffolding frame comprising a self-levelling apparatus. The invention also relates to a kit that can be used to modify an existing support apparatus to include a self-levelling apparatus.

Support apparatus, such as ladders, step ladders and scaffolding frames, is often used in locations where the ground surface is uneven. For example, building sites rarely offer a smooth and level surface on which to place support apparatus. The presence of uneven ground surfaces compromises the stability of conventional support apparatus, which tends to tilt sideways and can move in use. This can render the support apparatus unsafe to use or even dangerous.

Support apparatus with manually adjustable legs is known. However, manual adjustment of two or even four legs to achieve a stable and upright support apparatus involves extensive trial and error and can be time consuming. Furthermore, as the legs of support structures are generally in contact with the ground, adjustment can often be an awkward and dirty task.

Thus, there is a need for an improved means of levelling support apparatus such as ladders.

Alternative levelling mechanisms have been proposed. However, these mechanisms are associated with further problems.

U.S. Pat. No. 5,044,468 describes a ladder levelling device which uses a pair of connected hydraulic cylinder/piston units at the lower ends of the legs of a ladder to provide a measure of adjustment to an uneven surface. A valve is used to open and close fluid communication between the hydraulic units. When the valve is closed, the system resists the effect of forces, resulting for example from the weight of the support apparatus or the user climbing the support apparatus, from pushing the pistons into their respective cylinders.

Similar self levelling ladder systems are described in US 2008/0078616 A1 and GB 2340529 A. The mechanism described in GB 2340529 A is illustrated in the context of ladders and other types of support apparatus.

U.S. Pat. No. 5,044,468, US 2008/0078616 A1 and GB 2340529 A all rely on single acting hydraulic cylinders in which hydraulic fluid is present in a single working chamber on one side of the piston. On the other, lower, side of the piston, air is present and this can bleed into the working chamber if, for example, the piston is extended too rapidly or when the fluid connection between cylinders is closed. In the context of support apparatus such as a ladder, the presence of air in the working chambers of the hydraulic cylinders can lead to a degree of undesired movement, i.e. “springing” or “bounce”. This effect can significantly reduce the stability of such ladders in use and therefore compromise the safety of the user.

A further disadvantage of known hydraulic levelling systems for support apparatus is that they are only suitable for applications in which the weight of the support apparatus is transmitted directly through the cylinder and piston unit to the ground. For example, this arrangement is generally not suitable for support apparatus in which stabilizers are used to broaden the base of the apparatus. However, the use of such stabilizers is common, and may even be required by the relevant safety rules, for support apparatus of greater than about 1.5 m or about 2.0 m in height. Thus, the use of stabilizers is generally incompatible with single acting hydraulic systems.

Thus, there remains a need for improved levelling mechanism for support apparatus. It is therefore an object of the invention to provide an alternative and/or an improved support apparatus comprising such a levelling mechanism. A further object is to provide a retrofit solution for adapting and improving existing support apparatus.

Accordingly, a first aspect of the invention provides a support apparatus comprising at least first and second legs, wherein the support apparatus is provided with levelling means comprising: —

at the lower end of each of the first and second legs a cylinder and piston unit, wherein movement of the pistons of the cylinder and piston units relative to the cylinders permits variation in the length of each of the first and second legs;

fluid communication means for establishing at least one closed fluid passageway between the cylinder and piston units; and

valve means for controlling the passage of fluid through the fluid communication means

wherein in a first position, the valve means permit fluid to flow between the cylinder and piston units via the fluid communication means such that the length of each of the legs is accommodated to the profile of the ground, and wherein in a second position, the valve means do not permit fluid to flow between the cylinder and piston units thereby locking the cylinder and piston units in position.

The support apparatus of the invention typically further comprises actuating means for selectively moving the valve means between said first and second positions. This may take the form of a simple valve mechanism such as a stop tap, although other suitable mechanisms are known to the skilled person.

In preferred embodiments of the invention, the cylinder and piston units are dual acting hydraulic cylinder and piston units, each comprising upper and lower working chambers and wherein the upper and lower working chambers of the cylinder and piston unit on the first leg are separately in fluid communication with the corresponding upper and lower working chambers of the cylinder and piston unit on the second leg.

That is to say that the hydraulic cylinder and piston units each have two separate working chambers, one on either side of the piston, each served with separate fluid communication means. Thus, dual acting hydraulic units have two inlet/outlet points, one serving each working chamber. Such dual acting hydraulic units are widely available and are suitable for use in the context of the present invention.

The use of dual acting hydraulic units prevents movement of the pistons relative to the cylinders when the valve means are closed, and avoids the problems associated with air ingress and consequent lack of stability associated with single acting hydraulic systems. Hence, the use of dual acting hydraulic cylinder and piston units contributes to the improved stability and safety of the support apparatus of the invention.

When dual acting hydraulic cylinder and piston units are used, separate fluid communication channels link the upper and lower working chambers of the units on the first and second legs. Typically hydraulic tubing is used to provide these communication channels, and suitable examples are readily available to the skilled person. The communication channels can be fixed to the structure of the support apparatus using any suitable fixing, e.g. retaining clips and the like. Alternatively, the communication channels can form an integral part of the support apparatus, e.g. through the use of appropriately formed elements of the apparatus. By way of example, the side rails and one or more rungs of a ladder can be hollow, either in part or in their entirety, and the hollow voids can communicate with each other so as to form appropriate channels linking the hydraulic cylinder and piston units.

The communication channels can be provided with independent valve means, such that each channel is separately opened to allow adjustment of the legs or closed to lock the legs. However, in preferred embodiments a single mechanism is used to open and close both channels so that the actuating means simultaneously control fluid communication between the upper and lower working chambers of the cylinder and piston units.

In preferred embodiments, the actuating means is substantially perpendicular to the legs of the support apparatus when the valve means are in said first position and substantially parallel to the legs of the support apparatus when the valve means are in said second position. Typically the actuating means takes the form of a handle connected to the valve mechanisms for both fluid communication channels. For example, the valve mechanisms are conveniently located at similar positions along the first and second legs, such that movement of the handle out of the plane parallel to the first and second legs opens both valves and returning the handle to the plane parallel to the first and second legs closes both valves. This arrangement has the advantage that the handle (or other actuating means) is out of the way of the user when the valves are closed and the support apparatus is ready for use. However, the actuating means obstructs the user when the valves are open and the support apparatus is not yet ready for use. The effectiveness of this safety feature can be further enhanced by the optional application of a warning sign or symbol to a face of the handle only exposed to the user when the valves are open.

As noted above, it is often desirable to provide additional stabilization, particularly but not exclusively for support apparatus greater than about 1.5 m or about 2.0 m in height. Accordingly, in preferred embodiments of the invention at least the first and second legs of the support apparatus are provided with stabilizing means.

Various types of stabilizing means are known and available to the skilled person, and are suitable for use in the present invention. In some embodiments, the stabilizing means comprise a stabilizer bar attached to both the first and second legs. This provides a single element which links the lower ends of the first and second legs and extends beyond them, thus providing a pair of ground contact points more widely spaced than the first and second legs. Typically, the stabilizer bar is removably attached to the lower ends of the first and second legs using any appropriate type of fixing. In preferred embodiments, at least one of said fixings is slidably mounted on the stabilizer bar so as to allow for variations in the distance between the lower ends of the first and second legs resulting from accommodation of the apparatus to the profile of the ground.

In alternative embodiments of the invention, the stabilizing means comprises separate stabilizer members attached to the first leg and the second leg. In preferred embodiments, the stabilizer members are pivotably attached to the lower ends of the first and second legs, such that a first end of each stabilizer member contacts the ground and a second end of each stabilizer member is connected to one of the cylinder and piston units, thereby permitting variation in the length of each leg to be effected by controlling the degree of rotation of each stabilizer member about the respective pivot point on each leg. In such embodiments, the hydraulic cylinder and piston units may not be oriented parallel to the first and second legs of the support apparatus.

It will be appreciated that the term support apparatus, as used herein, encompasses ladders, step ladders, scaffolding frames, staging and the like. Such apparatus may be of any known type and construction. Suitable materials include aluminium, steel, metal alloys, wood or fibreglass. In preferred embodiments of the invention, the support apparatus is selected from the group consisting of a ladder, a step ladder and a scaffold frame.

In a particularly preferred embodiment the support apparatus is a ladder.

It is often desirable to use ropes or cables to move ladders into place, or otherwise move ladders up and down the face of a wall or building. In such circumstances, it is convenient to provide the ladders with elements to assist such movement, for example by providing wheels or continuous tracks which engage with the wall or building. Accordingly, in a preferred embodiment of the invention, an upper part of the ladder is provided with at least one wheel or continuous track. The continuous track may, for example, be a soft rubber track, optionally formed with gripping elements, and mounted on two or more rollers or wheels. Preferably, the rollers or wheels are provided with an interacting surface that interacts with an equivalent surface of the track in order to retain the track in position in use. This can conveniently be achieved by providing a recess or groove on the wheels which accommodates the track or a projection extending from the inner surface of the track. Typically wheels or tracks are provided on each of the first and second legs. In some embodiments, multiple pairs of such wheels or tracks are provided along the length of the ladder.

The provision of wheels or continuous tracks according to the invention can provide improved safety as well as assisting the movement of a ladder or other support apparatus to the position in which it is to be used. In particular, the provision of at least one wheel or continuous track can reduce sideways slippage of the upper part of the ladder across the face of a wall or building as a result of increased friction. This effect is particularly notable when one or more continuous tracks are provided, as such tracks provide an enlarged surface area of contact between the ladder and the wall or building. Thus, the provision of at least one wheel or continuous track can further contribute to, or further enhance, the improved stability resulting from the provision of levelling means according to the invention.

Other forms of support apparatus can also be provided with wheels or continuous tracks as described herein.

In further embodiments of the invention, the support apparatus is a step ladder or a scaffold frame. In such embodiments, the support apparatus can have four or, in the case of scaffold frames, more legs. These additional legs may be fixed legs, with the levelling mechanism being confined to the first and second legs. Alternatively, additional legs may also incorporate a levelling mechanism.

Accordingly, a further embodiment of the invention provides a support apparatus, wherein at least a third and fourth leg is provided with: —

a cylinder and piston unit, wherein movement of the pistons of the cylinder and piston units relative to the cylinders permits variation in the length of each of the third and fourth legs;

fluid communication means for establishing at least one closed fluid passageway between the cylinder and piston units; and

valve means for controlling the passage of fluid through the fluid communication means

wherein in a first position, the valve means permit fluid to flow between the cylinder and piston units via the fluid communication means such that the length of each of the legs is accommodated to the profile of the ground, and wherein in a second position, the valve means do not permit fluid to flow between the cylinder and piston units thereby locking the cylinder and piston units in position.

In certain embodiments of the invention, the cylinder and piston units on the first and second legs are in fluid communication with each other and the cylinder and piston units on the third and fourth legs are independently in fluid communication with each other. Similarly, additional pairs of legs, if present, can be provided with independent levelling mechanisms, comprising further cylinder and piston units, fluid communication means and valve means as described herein.

In alternative embodiments, the cylinder and piston units on each of the first to fourth legs (and other legs, if present) are mutually in fluid communication with each other. In such embodiments, a single multi-way valve can be used to control fluid flow between the cylinder and piston units. For example, an eight-way valve can be used for a support apparatus having four legs.

Step ladders and scaffold frames according to the invention may further be provided with one or more optional or preferred features of the invention as described herein. For example, each additional levelling mechanism provided for the third and fourth legs and subsequent pairs of legs can be provided with fluid communication channels and/or actuating means as described herein. In addition, the third and fourth legs and/or additional legs can optionally be provided with stabilizing means as described herein.

In some instances, it may be desirable to modify an existing support apparatus to incorporate a levelling mechanism according to the invention rather than providing a completely new support apparatus. Accordingly, the present invention provides methods for retrofitting support apparatus with a levelling mechanism according to the invention. This is conveniently achieved by providing a kit, comprising elements suitable for adapting support apparatus according to the invention.

Accordingly, in a second aspect, the invention provides a kit for adapting a support apparatus comprising: —

at least one pair of cylinder and piston units;

fluid communication means for establishing at least one closed fluid passageway between the cylinder and piston units; and

valve means for controlling the passage of fluid through the fluid communication means

wherein in a first position, the valve means permit fluid to flow between the cylinder and piston units via the fluid communication means such that the pistons can move relative to the cylinders of the cylinder and piston units, and wherein in a second position, the valve means do not permit fluid to flow between the cylinder and piston units thereby locking the cylinder and piston units in position.

The kit preferably further comprises actuating means for selectively moving the valve means between said first and second positions. The actuating means can be of any suitable type, for example as described herein.

In preferred embodiments, the kit comprises cylinder and piston units which are dual acting hydraulic cylinder and piston units, each comprising upper and lower working chambers and wherein the upper and lower working chambers of a first cylinder and piston unit are separately in fluid communication with the corresponding upper and lower working chambers of a second cylinder and piston unit.

The kit may optionally comprise fixing means for attaching the cylinder and piston units to at least first and second legs of a support apparatus. Further fixing means can be provided for securing additional cylinder and piston units to additional legs of the support apparatus, if present, and/or for attaching the fluid communication means to the support apparatus. Suitable fixing means will be familiar to the skilled person, for example nuts and bolts, retaining brackets and clips, and the like.

There now follows a description of a specific embodiment of the present invention, accompanied by drawings, in which: —

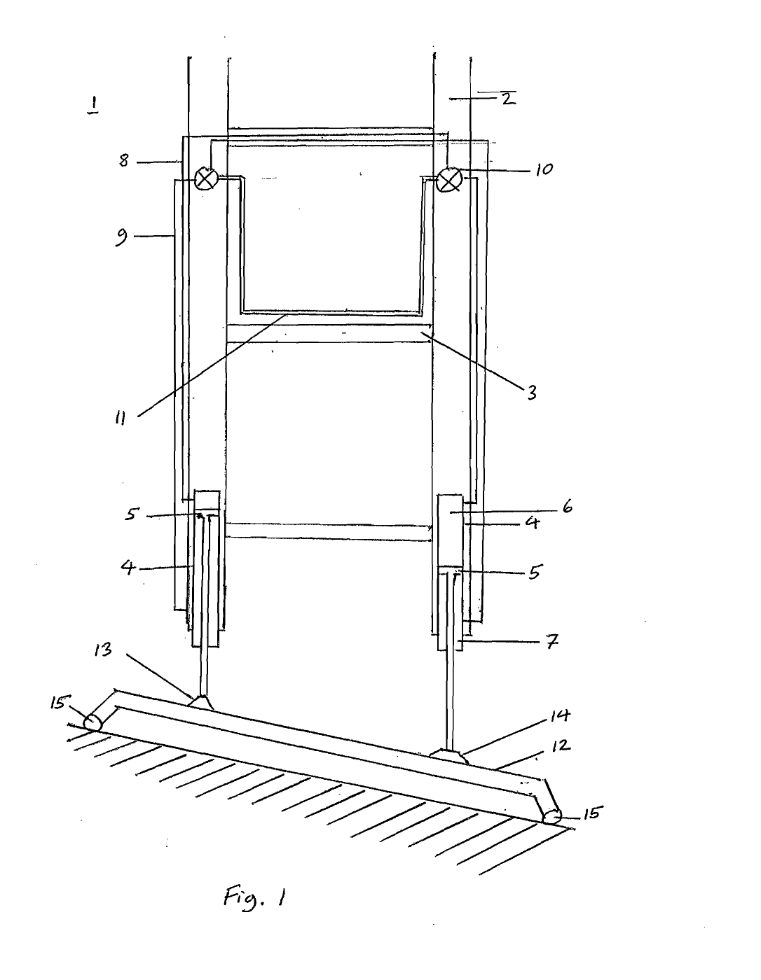

FIG. 1 shows the lower portion of a ladder according to the invention;

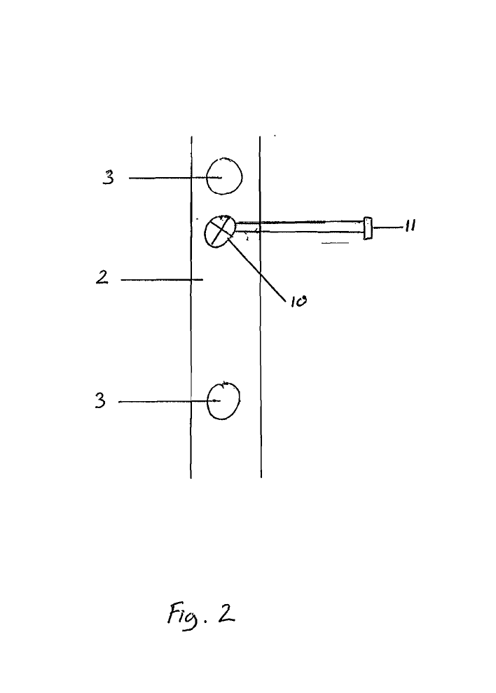

FIG. 2 shows a side view of part of a ladder of the invention, including a preferred actuating means;

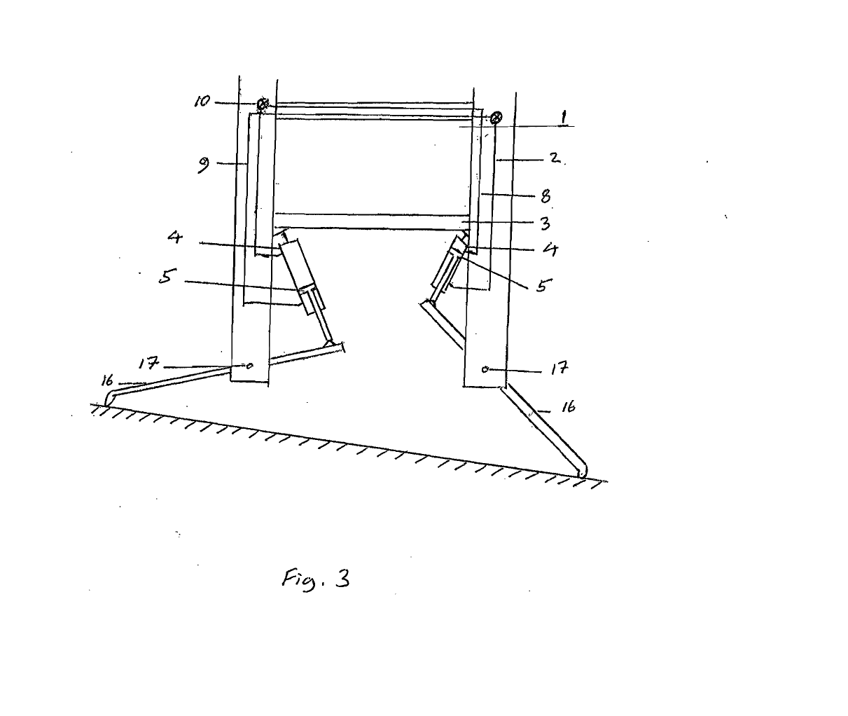

FIG. 3 shows the lower portion of an alternative ladder of the invention; and

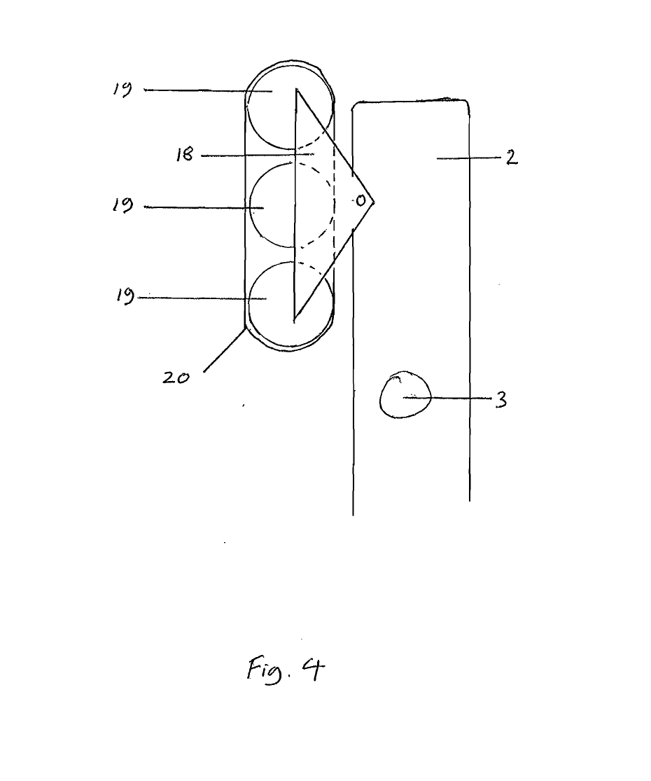

FIG. 4. shows part of a ladder of the invention fitted with a continuous track.

Referring to FIGS. 1 to 4, a ladder according to a preferred embodiment of the invention is shown generally as 1 and comprises side rails or legs 2 and rungs 3. Dual acting hydraulic cylinder and piston units are fitted to the lower part of the side rails, each comprising a cylinder 4 and a piston 5 which define upper and lower working chambers 6 and 7. The upper working chambers and lower working chambers are connected to each other by fluid communication channels 8 and 9, which may be incorporated into or attached to the structure of the ladder. Each fluid communication channel is provided with a valve 10, which allows each channel to be opened or closed, thus permitting or preventing fluid flow between the linked working chambers of the cylinder and piston units.

FIG. 1 further shows actuating means taking the form of a handle 11, which is connected to both valves 10 controlling the fluid communication channels 8 and 9. Rotation of the handle 11 out of the plane of the ladder results in the opening of the valves, thus permitting the pistons 5 to move relative to the cylinders 4 in order to achieve levelling relative to the ground. Returning the handle to the plane of the ladder closes the vales and prevents further extension or retraction of the pistons relative to the cylinders.

A side view of the actuating means is shown in FIG. 2. This shows, in particular, how the position of the handle 11, when the valves are open, prevents the user from climbing the ladder when the valves 10 are open. In contrast, when the valves are closed and the handle 11 is in the position indicated in FIG. 1, access is not impeded and the user can climb the ladder whilst the pistons 5 are locked in position relative to the cylinders 4.

The ladder of FIG. 1 is further provided with a stabilizer bar 12, which is attached to the ladder by fixings 13 and 14 and which contacts the ground at its ends 15. The angle of the stabilizer bar 12 will vary according to the profile of the ground underneath the ladder and hence the angle of the stabilizer bar relative to the legs 2 will vary. Accordingly, fixing 14 is slidably mounted on the stabilizer bar, e.g. by providing an interacting slot and corresponding projection on the stabilizer bar and/or the fixing, to allow the levelling mechanism to move as required when the valves 10 are open.

FIG. 3 shows an alternative embodiment in which each leg 2 is provided with independent stabilizer members 16, each pivotably attached to the legs at a hinge point 17. Motion of the stabilizer members about the hinge point provides accommodation to the profile of the ground when the valves controlling the fluid communication channels are open, and is prevented when the valves are closed.

FIG. 4 shows a side view of one side rail 2, fitted with a continuous track mechanism which allows the ladder to be rolled up and down a wall. The mechanism comprises a fixing 18 which connects the track to the side rail, rollers 19 and a track 20. the track 20 is typically made of soft rubber, and moves around the rollers 19 when the ladder is moved up or down a wall, thus reducing friction between the ladder and the wall and minimising potential damage to the wall.

The invention thus provides a self-levelling support apparatus, and a kit for adapting pre-existing support apparatus to incorporate a self-levelling mechanism.

1.-20. (canceled)

21. A support apparatus comprising at least first and second legs, wherein the support apparatus is provided with levelling means comprising:
at a lower end of each of the first and second legs a cylinder and piston unit, wherein movement of the pistons of the cylinder and piston units relative to the cylinders permits variation in the length of each of the first and second legs;
fluid communication means for establishing at least one closed fluid passageway between the cylinder and piston units; and
valve means for controlling the passage of fluid through the fluid communication means,
wherein in a first position, the valve means permit fluid to flow between the cylinder and piston units via the fluid communication means such that the length of each of the legs is accommodated to the profile of the ground, and wherein in a second position, the valve means do not permit fluid to flow between the cylinder and piston units thereby locking the cylinder and piston units in position.

22. The support apparatus of claim 21, further comprising actuating means for selectively moving the valve means between said first and second positions.

23. The support apparatus of claim 21, wherein the cylinder and piston units are dual acting hydraulic cylinder and piston units, each comprising upper and lower working chambers and wherein the upper and lower working chambers of the cylinder and piston unit on the first leg are separately in fluid communication with the corresponding upper and lower working chambers of the cylinder and piston unit on the second leg.

24. The support apparatus of claim 23, wherein the actuating means simultaneously control fluid communication between the upper and lower working chambers of the cylinder and piston units.

25. The support apparatus of claim 24, wherein the actuating means is substantially perpendicular to the legs of the support apparatus when the valve means are in said first position and substantially parallel to the legs of the support apparatus when the valve means are in said second position.

26. The support apparatus of claim 21, wherein at least the first and second legs are provided with stabilizing means.

27. The support apparatus of claim 26, wherein the stabilizing means comprise a stabilizer bar attached to both the first and second leg.

28. The support apparatus of claim 26, wherein the stabilizing means comprises separate stabilizer members attached to the first leg and the second leg.

29. The support apparatus of claim 28, wherein the stabilizer members are pivotably attached to the lower ends of the first and second legs, such that a first end of each stabilizer member contacts the ground and a second end of each stabilizer member is connected to one of the cylinder and piston units, thereby permitting variation in the length of each leg to be effected by controlling the degree of rotation of each stabilizer member about the respective pivot point on each leg.

30. The support apparatus of claim 21, wherein the support apparatus is selected from the group consisting of a ladder, a step ladder, and a scaffold frame.

31. The support apparatus of claim 30, wherein the support apparatus is a ladder.

32. The support apparatus of claim 31, wherein an upper part of the ladder is provided with at least one wheel or continuous track.

33. The support apparatus of claim 30, wherein the support apparatus is a step ladder or a scaffold frame.

34. The support apparatus of claim 33, wherein at least a third and fourth leg is provided with:
a cylinder and piston unit, wherein movement of the pistons of the cylinder and piston units relative to the cylinders permits variation in the length of each of the third and fourth legs;
fluid communication means for establishing at least one closed fluid passageway between the cylinder and piston units; and
valve means for controlling the passage of fluid through the fluid communication means,
wherein in a first position, the valve means permit fluid to flow between the cylinder and piston units via the fluid communication means such that the length of each of the legs is accommodated to the profile of the ground, and wherein in a second position, the valve means do not permit fluid to flow between the cylinder and piston units thereby locking the cylinder and piston units in position.

35. The support apparatus of claim 34, wherein the cylinder and piston units on the first and second legs are in fluid communication with each other and the cylinder and piston units on the third and fourth legs are independently in fluid communication with each other.

36. A kit for adapting a support apparatus comprising: —
at least one pair of cylinder and piston units;
fluid communication means for establishing at least one closed fluid passageway between the cylinder and piston units; and
valve means for controlling the passage of fluid through the fluid communication means,
wherein in a first position, the valve means permit fluid to flow between the cylinder and piston units via the fluid communication means such that the pistons can move relative to the cylinders of the cylinder and piston units, and wherein in a second position, the valve means do not permit fluid to flow between the cylinder and piston units thereby locking the cylinder and piston units in position.

37. The kit of claim 36, further comprising actuating means for selectively moving the valve means between said first and second positions.

38. The kit of claim 36, wherein the cylinder and piston units are dual acting hydraulic cylinder and piston units, each comprising upper and lower working chambers and wherein the upper and lower working chambers of a first cylinder and piston unit are separately in fluid communication with the corresponding upper and lower working chambers of a second cylinder and piston unit.

39. The kit of claim 36, further comprising fixing means for attaching the cylinder and piston units to at least first and second legs of a support apparatus.
